(19) United States
(12) Patent Application Publication
(10) Pub. No.: US 2004/0103332 A1
(43) Pub. Date: May 27, 2004

(54) Method of managing power source consumption of the portable information processing device

(76) Inventors: Ta-Feng Huang, Taoyuan Hsien (TW); Ming-Hsiu Fu, Shijr City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/303,960

(22) Filed: Nov. 26, 2002

(51) Int. Cl. G06F 1/26

(52) U.S. Cl. 713/340

(57) ABSTRACT

The present invention is a method of managing power source consumption of a portable information processing device, when the portable information processing device is under working, a detection mechanism detects the power source consumption of the portable information processing device. If the CPU power consumption of the portable information-processing device exceeds a pre-set value, the invention employs a regulation mechanism to decrease of the power consumption, so as to achieve the power source consumption management of the portable information processing device.

### BACKGROUND OF THE INVENTION

(1) Field of the Invention

The present invention relates to a method of managing power source consumption, and more particularly to a kind of method that is applied to the management of working electric power of the portable information processing device.

(2) Description of the Prior Art

The portable information processing device came from laptop computer in the late 1980. The portable computer(Notebook) at the initial stage weighed about 5 to 6 Kg using a monochrome LCD monitor; its weight, lighter than a desktop computer, though, was far from the ideal of a portable computer. With the increasingly developed technology, the design of a portable information processing device has largely improved in the weight within several years.

The portable information processing device had been used for military that has to maintain high mobility during the war. However, the limits of weight and volume of the former designed notebook computer failed to move computers easily, the military requested their computers to consist of the functions of portable, easily to be set up and used, such ideas further went into practice and developed the current portable information processing device.

For instance, a total amount of power watts consumption of the CPU and other system design of existing notebook computer usually exceed 100 watts. The power consumption of a Notebook computer to the manufacturers causes the following problems: the adaptor for supplying 100 watts

1. causes higher price;

2. is being unpopular among those suppliers;

3. results in larger volume;

4. as the current adaptor standard of a notebook computer is within 90 watts, therefore, a notebook computer, excepting for the preceding three considerations, the power consumption of CPU and the system will be up to 100 watts or above, which will not pass through the standard to EMI to obtain a EMI certification.

The same problem may happen to other relevant portable information processing device.

With the increasing requirement of an information processing device with the mobility characteristic at present times, the portable information processing device, having the advantages of light and small, has become a mainstream design. However, most of the portable information processing devices have built-in batteries to maintain required electric power during working, as there may not have electric power under some of working conditions. The electric power is to supply the apparatus devices of a computer, such as a monitor, discs, a keyboard and a mouse; nevertheless, the battery can not supply required electric power to the portable information processing device during a long period of time.

Since the electric power can not be replenished, how to save the power consumption of the portable information processing device, in the meanwhile, enable the poser supply to conform to EMI standard have become a under-resolved subject.

### SUMMARY OF THE INVENTION

In view of the foregoing disadvantages, the present invention proposes a method of managing power source consumption of the portable information processing device. The object of the present invention is to control the power source consumption of the portable information processing device during working to maintain normal working of the portable information processing device.

The present invention consists of a detection mechanism and a regulation mechanism. When the portable information processing device is under working, the detection mechanism detects the power source consumption of the portable information processing device. If the CPU power consumption of the portable information processing device exceeds a pre-set value, the invention employs the regulation mechanism to decrease of the power consumption, so as to achieve the power source consumption management of the portable information processing device.

In addition, as the portable information processing device is not frequently under the charging condition, the system usually proposes an optimal setup to enable the portable information processing device not to reach the non-maximal function status, to avoid electric power from excessive consumption. The invention, under such a principle to accommodate to EMI, detects if the power consumption exceeds a pre-set value; if so, the invention starts to carry out the electric power regulation, which may result in failing to achieve the maximal function of the portable information processing device, but appropriate regulation of the function setup in the portable information processing device based on a user's requirement will be made for the user to operate.

The foregoing and many other aspects of the present invention will no doubt become obvious to those of ordinary skill in the art after having read the following detailed description of the preferred embodiments that are illustrated in the figures of the accompanying drawings.

### BRIEF DESCRIPTION OF THE DRAWINGS

FIG. 1 is a flowchart (1) of the method of managing power source consumption of the portable information processing device of the present invention;

FIG. 2 is a flowchart (2) of the method of managing power source consumption of the portable information processing device of the present invention;

FIG. 3 is an embodiment of the method of managing power source consumption of the portable information processing device of the present invention.

### DETAILED DESCRIPTION OF THE PREFERRED EMBODYMENTS

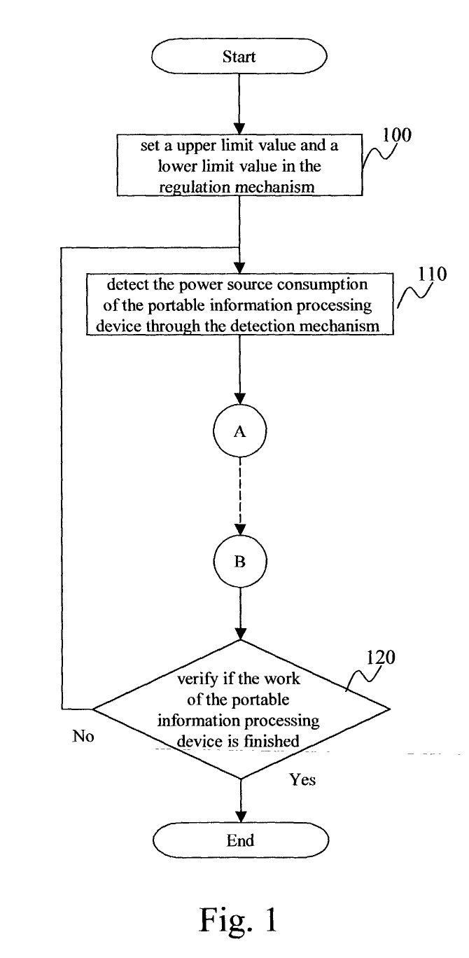

The present invention disclosed herein is directed to a method of managing power source consumption of the portable information processing device. Please refer to FIG. 1, the flowchart (1) of the method of managing power source consumption of the portable information processing device of the present invention.

The present invention comprising of the detection mechanism 30 and the regulation mechanism 50. first, the invention starts up the portable information processing device, and then carries out the setup process to enable a upper limit value and a lower limit value to be set at the regulation mechanism 50(step 100). When the portable information processing device under working, the detection mechanism 30 detects the power source consumption of the portable information processing device(step 110), and starts up the step of electric power of the portable information processing device and goes into process A. In addition, the invention verifies if the work of portable information processing device is finished after the completion of process B(step 120). If YES, the invention then finishes all operations and switches off the electric power of the portable information processing device; if NO, the invention then goes back to (step 110) continuing working.

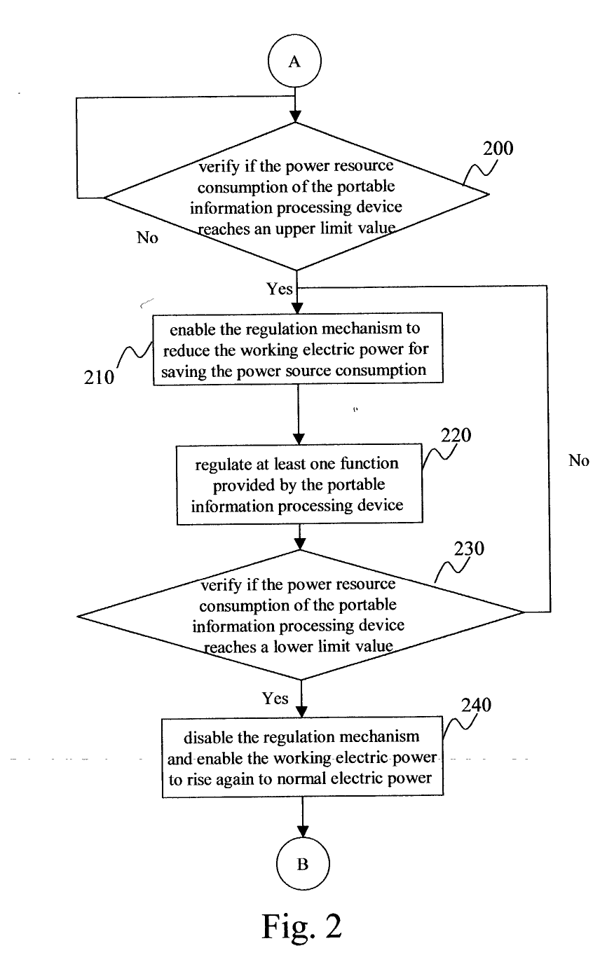

The preceding steps of the start-up of the electric power of the portable information processing device are detailed as follows. Referring to FIG. 2, the flowchart (2) of the method of managing power source consumption of the portable information processing device of the present invention.

At the same time when the detection mechanism 30 detects the power source consumption of the portable information processing device, it can verify if the power source consumption of the portable information processing device reaches to an upper limit value (step 200). If NO, the process goes back to step 200 and continues the detection; if YES, the process enables the regulation mechanism 50 to reduce electric power for saving the power source consumption(step 210). During the process of reducing electric power, the regulation mechanism 50 starts to adjust at least one function provided by the portable information processing device (step 220), the function can be led through the system to enable a user to choose the function, which requires to be regulated, such as reducing outputted power of the sound, mitigating the brightness of display, regulating memory clock, regulating the rotational speed of fan and CPU efficiency, etc. The detection mechanism 30 then verifies if the power source consumption of the portable information processing device reaches a lower limit value (step 230), if NO, the electric power is still under working area; if YES, the result shows that the electric power is not capable of bear the work of the portable information processing device. The process then disables the regulation mechanism and enables the electric power to go up the normal electric power again (step 240); the flow ends up here.

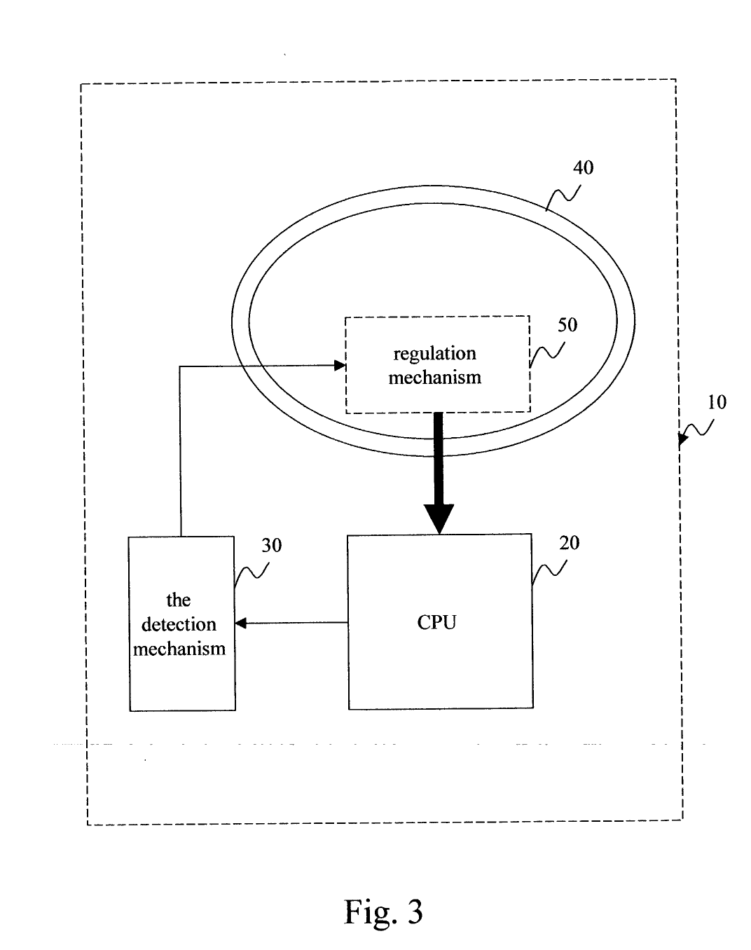

At last, the present invention depicts an embodiment for details as shown in FIG. 3. FIG. 3 is the embodiment of the method of managing power source consumption of the portable information processing device of the present invention.

The present invention sets the detection mechanism 30 and the regulation mechanism 50 in the portable information processing device 10, which can be selected from either a NB (Notebook), or a PDA (Personal Digital Assistant). The detection mechanism 30, connecting to the CPU 20(CPU), aims at receiving working electric power from the CPU 20(CPU) to verify the working status of the portable information processing device 10, the regulation mechanism 50, set in a BIOS 40(Basic Input Output System; BIOS), further comprising of a upper limit value and a lower limit value. During the working of the portable information processing device 10, the detection mechanism 30 detects if the working power source consumption of the CPU 2 reaches an upper limit value, if NO, the process continues comparing the working power source consumption with the upper limit value; if YES, the process enables the regulation mechanism 50 orders the electric power of the CPU 20 to decrease for saving the consumption. For the time being that the working electric power is in linear decreasing, at the same time, the detection mechanism 30 detects the decrease of the working electric power of the CPU 20. If the working electric power of the CPU 20 does not decrease to a lower limit value, the process continues comparing the decrease of the electric power with the lower limit value; if YES, the process disables the regulation mechanism 50, enables the working electric power of the CPU 20 to be in linear rising, and goes back to the step of comparing the working power source consumption and the upper limit value to continue managing the consumption of the working electric power.

When the regulation mechanism 50 gives an order to enable the working electric power of the CPU 20 decrease for saving the consumption, the invention provides a kind customized mode led through the system to enable a user to select the function, which is required to be adjusted, to regulate at least one function provided by the portable information processing device. To match the characteristics of the portable information processing device achieving the objective of the best efficiency, the invention, during the management process, decreases the power source consumption to match up the problem of EMI, and then ensures part of functions to be simultaneously regulated, at the same time of decreasing the electric power, based on a user's requirement through the customized regulation function mode.

In addition, the invention further installs a System Management Interrupt (SMI) in between the detection mechanism 30 and the regulation mechanism 50. The SMI is to deliver messages of the detection mechanism 30 to the regulation mechanism 50.

It is of course to be understood that the embodiment described herein is merely illustrative of the principles of the invention and that a wide variety of modifications thereto may be effected by persons skilled in the art without departing from the spirit and scope of the invention as set forth in the following claims.

I claims:

1. A method of managing power source consumption of the portable information processing device is applied to a portable information processing device to manage a working electric power of the portable information processing device through a detection mechanism and a regulation mechanism, the method comprising the following steps:
detecting the working power source consumption of the portable information processing device through the detection mechanism;
enabling the regulation mechanism to decrease the working electric power for saving the consumption;
detecting the decrease of the working electric power of the portable information processing device through the detection mechanism; and
disabling the regulation mechanism and enabling the working electric power to rise again.

2. The method of managing power source consumption of the portable information processing device in accordance with claim 1, wherein the regulation mechanism further comprises a step of setting an upper limit value.

3. The method of managing power source consumption of the portable information processing device in accordance with claim 1, wherein the regulation mechanism further comprises a step of setting a lower limit value.

4. The method of managing power source consumption of the portable information processing device in accordance with claim 1, wherein the step of detecting the working power source consumption of the portable information processing device through the detection mechanism further comprises a step of comparing the working power source consumption with the upper limit value.

5. The method of managing power source consumption of the portable information processing device in accordance with claim 4, wherein the working power source consumption at the step of comparing the working power source consumption with the upper limit value exceeds the upper limit value, it goes into a step of enabling the regulation mechanism.

6. The method of managing power source consumption of the portable information processing device in accordance with claim 4, wherein the working power source consumption at the step of comparing the working power source consumption with the upper limit value does not exceed the upper limit value, the process continues comparing the working power source consumption with the upper limit value.

7. The method of managing power source consumption of the portable information processing device in accordance with claim 1, wherein the step of detecting the decrease of the working electric power of the portable information processing device through the detection mechanism further comprises a step of comparing the decrease of the working electric power with the lower limit value.

8. The method of managing power source consumption of the portable information processing device in accordance with claim 7, wherein the working electric power at the step of comparing the decrease of the working electric power with the lower limit value is lower than the lower limit value, the process goes into a step of disabling the regulation mechanism.

9. The method of managing power source consumption of the portable information processing device in accordance with claim 7, wherein the decrease of the working electric power at the step of detecting the decrease of the working electric power of the portable information processing device through the detection mechanism is higher than the lower limit value, the process continues comparing the decrease of the working electric power with the lower limit value.

10. The method of managing power source consumption of the portable information processing device in accordance with claim 1, wherein the step of enabling the regulation mechanism to decrease the working electric power for saving the consumption provides a customized mode to regulate at least one function, which is provided by the portable information processing device.

11. The method of managing power source consumption of the portable information processing device in accordance with claim 10, wherein the customized mode is led through the system to enable a user to select a function, which is required to be regulated.

12. The method of managing power source consumption of the portable information processing device in accordance with claim 1, wherein the regulation mechanism is further set in a BIOS of the portable information processing device.

13. The method of managing power source consumption of the portable information processing device in accordance with claim 1, wherein the working electric power is further the working electric power of a CPU of the portable information processing device.

14. The method of managing power source consumption of the portable information processing device in accordance with claim 1, wherein the detection mechanism and the regulation mechanism further include a System Management Interrupt(SMI) in-between; the SMI is to deliver a message of the detection mechanism to the regulation mechanism.

15. The method of managing power source consumption of the portable information processing device in accordance with claim 1, wherein the portable information processing device can be selected from either a PDA (Personal Digital Assistant) or a notebook computer.
